(19) United States
(12) Patent Application Publication
(10) Pub. No.: US 2024/0210723 A1
(43) Pub. Date: Jun. 27, 2024

(54) REFLECTIVE IMAGING FILM

(71) Applicant: SOOCHOW UNIVERSITY, Suzhou (CN)

(72) Inventors: Su SHEN, Suzhou (CN); Yun ZHOU, Suzhou (CN)

(21) Appl. No.: 17/912,674

(22) PCT Filed: Oct. 9, 2021
(86) PCT No.: PCT/CN2021/122762

§ 371 Date: Sep. 19, 2022

(30) Foreign Application Priority Data
Aug. 25, 2021 (CN) 202110983747.3

(51) Int. Cl. G02B 30/35

(52) U.S. Cl. CPC G02B 30/35

(57) ABSTRACT

The invention provides a reflective imaging film, including: a transparent separation layer, the transparent separation layer including a first surface and a second surface arranged opposite to each other; a microfocus element array layer, which is laminated on the first surface and at least includes three microfocus units; a reflective layer covering an outer surface of the microfocus element array layer, the microfocus element array layer and the reflective layer forming a reflective microfocus layer; and a micropattern layer, which is arranged on the second surface and at least includes three micropattern units, the micropattern units being different from each other, and the micropattern layer being obtained through projection and imaging of a partial cut of a whole virtual three-dimensional image by the reflective microfocus layer, a three-dimensional image with a continuous parallax and an occlusion relationship is observable through the transparent separation layer.

### FIELD OF THE INVENTION

The present invention relates to the field of optical anti-counterfeiting technologies, and in particular, to a reflective imaging film.

### DESCRIPTION OF THE RELATED ART

In recent years, the domestic market in China is flooded with counterfeit and shoddy goods such as food, various brand-name alcoholic drinks, beverages, cigarettes, drugs, health care products, cosmetics, detergents, clothing, footwear, film, medical equipment, steel, cement, chemical materials, fertilizers, pesticides, seeds, auto parts, and TV sets. From the field of social security, there are also a large number of counterfeit banknotes, stamps, various valuable securities, resident ID cards, household's register, graduation certificates, official seals, and the like. The variety, the wide range of distribution, and the seriousness of the consequences of counterfeit and shoddy goods are really alarming. In particular, counterfeit banknotes, stamps, and other valuable securities cause the most serious harm to society. Therefore, it is especially important to study the prevention of product counterfeiting, the use of science and technology to protect high-quality brand-name products, and the elimination of the harm caused by counterfeit and shoddy goods to these goods.

Common popular anti-counterfeiting technologies mainly include printing, watermarking, laser holography, color-changing ink, and the like. Printing and watermarking are prone to copy and imitation through digital photography, scanning, copying, and the like. In recent years, people have researched many different types of color-changing inks such as temperature-changing, light-changing, and fluorescent inks. Color-changing inks must be combined with other technologies to implement anti-counterfeiting. Laser holographic technology has attracted people's widespread attention based on the holographic imaging principle and colorful flash, dynamic, and three-dimensional effects, and was once recognized as the most advanced and economical technology. However, with the widespread use of holography in the fields of tickets, trademarks, packaging, and the like, many manufacturers have the ability to produce holographic products, and as a result the laser holographic anti-counterfeiting technology is facing a crisis. Therefore, there is an urgent need to find a new-generation mass anti-counterfeiting technology that meets high technology, low cost, and easy identification.

In 1994, M. C. Hutley et al. proposed a Moire magnification technique that can be applied to anti-counterfeiting marking. The Moire magnification technique involves a phenomenon that occurs when an array of identical micropatterns is observed from an array of microlenses with approximately the same periodic dimension, that is, in the form of a magnification or rotation of the micropatterns. The basic principle of the Moire magnification technique is described in M. C. Hutley, R. Hunt, R. F. Stevens, and P. Savander, Pure Appl. Opt. 3 (1994), pp. 133-142. Later, Drinkwater et al. were the first to propose a secure device combining a hemispherical microlens array with a microimage array in US Patent U.S. Pat. No. 5,712,731A.

However, because microimages in a microimage array used in this technology are identical, the microimages only record the shape and light intensity of a target scene in a direction. The images displayed through a security film are presented in the same plane, highlighted in front of the security film or recessed in the security film and changing along with an observation perspective. The images are subject to a continuous translation jump. The microimages are identical and the displayed image can be highlighted outside the film or recessed in the film, but are still distributed in the same plane. As an inevitable result, the security film is susceptible to copy and causes difficulty in identification. Chinese invention patent CN103236222B discloses an anti-counterfeit security film based on the principle of integrated imaging and having a dynamic three-dimensional effect, including a microlens array layer and a unit image array layer. The unit image array layer includes a plurality of unit images storing image information of different perspectives of a target scene. The microlens array layer includes microlenses that are arranged in a one-to-one correspondence to the unit images and are used for imaging of the unit images. However, micropattern bits of the microlens array layer are generated by using an optical imaging device to shoot and image a target object and still have the defect of jumping with the viewpoint due to the use of a transmission mode.

### SUMMARY OF THE INVENTION

For this, a technical problem to be resolved by the present invention is to overcome technical disadvantages in the prior art that an imaging film changes along with an observation perspective, and images are subject to a continuous translation jump.

To resolve the foregoing technical problems, the present invention provides a reflective imaging film, including a reflective imaging film:
a transparent separation layer, the transparent separation layer including a first surface and a second surface arranged opposite to each other;
a microfocus element array layer, the microfocus element array layer being laminated on the first surface, the microfocus element array layer at least including three microfocus units;
a reflective layer, the reflective layer covering an outer surface of the microfocus element array layer, the microfocus element array layer and the reflective layer forming a reflective microfocus layer; and
a micropattern layer, arranged on the second surface, the micropattern layer at least including three micropattern units, the micropattern units being different from each other, the micropattern layer being obtained through projection and imaging of a partial cut of a whole virtual three-dimensional image by the reflective microfocus layer,
where a three-dimensional image with a continuous parallax and an occlusion relationship is observable through the transparent separation layer.

Preferably, a method for preparing the micropattern layer is as follows:
S1. obtaining a three-dimensional view of a target virtual image;
S2. dividing, according to a visual occlusion status, a three-dimensional view of a virtual image observable at a viewing angle of human eyes, to obtain a discrete image point set;
S3. making the discrete image point set sequentially pass through the transparent separation layer and the reflective microfocus layer in a viewing angle direction of the human eyes, reflecting the discrete image point set to the second surface of the transparent separation layer, and obtaining a corresponding discrete object point set at the second surface of the transparent separation layer, the discrete object point set forming a micropattern unit corresponding to the viewing angle observed of the human eyes; and
S4. traversing all observation viewing angles of the human eyes, and repeating S2 and S3 to obtain a micropattern array layer.

Preferably, S3 includes:
setting a distance between a preset point x_{L} in the discrete image point set and the imaging film to L, a refractive index of the imaging film to n, a thickness of the imaging film to 1, a radius of curvature of each microfocus unit to R, a coordinate of an i^{th} microfocus element along an x axis to x_{i,MLA}, and an included angle between the preset point x_{L} and the microfocus element to a_{L}
the coordinate x and the angle a_{L} of the position of a discrete object point of a light ray reflected to the micropattern layer satisfying:

$$( \begin{matrix}x \\ α\end{matrix} ) = ( \begin{matrix}1 & l \\ 0 & 1\end{matrix} ) ( \begin{matrix}1 & 0 \\ - \frac{2}{R} & 1\end{matrix} ) ( \begin{matrix}1 & - l \\ 0 & 1\end{matrix} ) ( \begin{matrix}1 & 0 \\ 0 & \frac{1}{n}\end{matrix} ) [ ( \begin{matrix}{x}_{i , MLA} \\ 0\end{matrix} ) + ( \begin{matrix}1 & - L \\ 0 & 1\end{matrix} ) ( \begin{matrix}{x}_{L} \\ {α}_{L}\end{matrix} ) ] ,$$

where the x axis is parallel to a surface of the imaging film.

Preferably, a period T of the reflective microfocus layer, a thickness D of the imaging film, and a refractive index n of the imaging film are designed by the following steps:

constructing a relational expression between a maximum viewing angle θ keeping hop crosstalk from occurring in the imaging film and the period T of the reflective microfocus layer, the thickness D of the imaging film, and the refractive index n of the imaging film:

$$θ = asin ( n \frac{T}{\sqrt{{T}^{2} + {D}^{2}}} ) ;$$

and

adjusting parameter values of T, D, and n, so that the maximum viewing angle θ keeping hop crosstalk from occurring in the imaging film is equal to 90 degrees.

Preferably, no optical interface is provided between any two of the micropattern layer, the transparent separation layer, and the reflective microfocus layer.

Preferably, a thickness of the transparent separation layer is less than 0.06 mm.

Preferably, each micropattern unit includes a plurality of lattices, and each microfocus unit at least covers one lattice or some microfocus units cover no lattice.

Preferably, the reflective layer is made from chromium, aluminum or silver, and a film thickness of the reflective layer ranges from 20 nm to 100 nm.

Preferably, the micropattern unit includes a groove and a color nano ink filled in the groove.

Preferably, the micropattern layer is arranged within a range of +20% of an optimal imaging distance of the reflective microfocus layer.

Compared with the prior art, the foregoing technical solution of the present invention has the following advantages:
1. The micropattern in the present invention includes a plurality of micropattern units. The micropattern units are different from each other. In addition, because the micropattern units are obtained through projection and imaging of a partial cut of a whole virtual three-dimensional pattern by the reflective microfocus layer, it is not possible to find out complete object and image information from a single micropattern unit, specific copy is highly difficult, and counterfeiting becomes impossible.
2. The present invention provides a three-dimensional imaging film. The reflective microfocus layer and the micropattern layer work together to provide a real three-dimensional image with a full field of view and dense points of view.
3. The three-dimensional visual effect in the present invention is not susceptible to external ambient light, the effect is visible to naked eyes without wearing glasses, and the advantages of a change along with a view angle and a realistic three-dimensional effect are achieved.
4. The present invention has a wide application range and is of significant application value in fields such as three-dimensional imaging and visual counterfeiting.

### BRIEF DESCRIPTION OF THE DRAWINGS

FIG. 1 is a schematic structural diagram of a reflective imaging film according to the present invention;

FIG. 2 is a schematic diagram of a virtual three-dimensional object established with a dice as an example;

FIG. 3 is a schematic diagram of projection and imaging of a point on a virtual object onto a reflective microfocus array layer;

FIG. 4 is a schematic diagram of a micropattern unit in a micropattern layer calculated according to an occlusion relationship with a dice as an example, where a projection status of three surfaces with a surface normal direction facing upward of a dice are represented;

FIG. 5 is a schematic diagram of a micropattern unit in a micropattern layer calculated according to an occlusion relationship with a dice as an example, where a projection status of three surfaces with a surface normal direction facing upward of a dice are represented;

FIG. 6 is a schematic structural diagram of units in a partial area of a micropattern layer; and

FIG. 7 is a schematic structural diagram of calculating a viewing angle according to the present invention.

Reference numerals: 11. micropattern layer; 12. transparent separation layer; 13. microfocus element array layer; and 14. reflective layer.

### DETAILED DESCRIPTION OF THE PREFERRED EMBODIMENTS

The present invention is further described below with reference to the accompanying drawings and specific embodiments, to enable a person skilled in the art to better understand and implement the present invention. However, the embodiments are not used to limit the present invention.

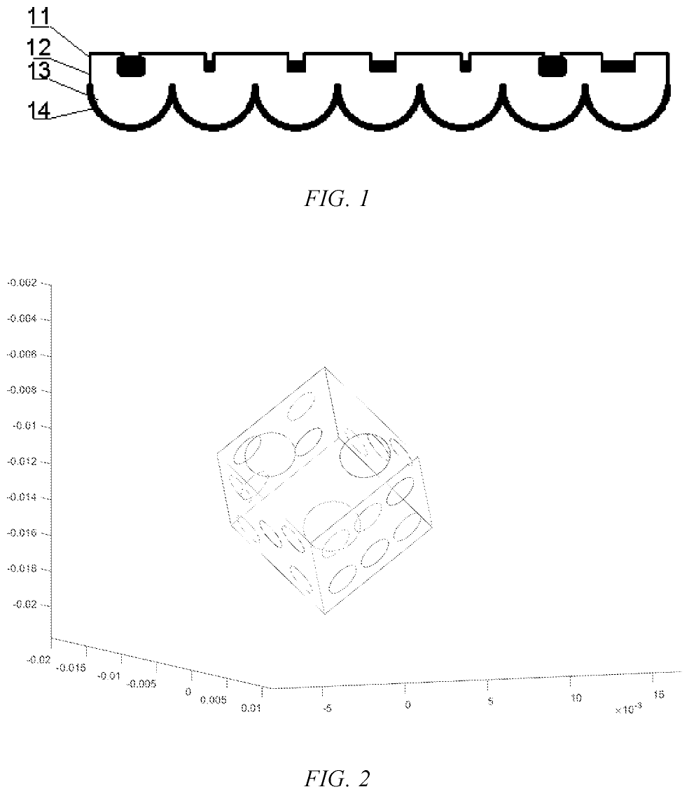

Referring to FIG. 1, disclosed in the present invention is a reflective imaging film, including a transparent separation layer, a microfocus element array layer, a reflective layer, and a micropattern layer.

The transparent separation layer 12 includes a first surface and a second surface arranged opposite to each other. The microfocus element array layer 13 is laminated on the first surface. The microfocus element array layer 13 at least includes three microfocus units. The reflective layer 14 covers an outer surface of the microfocus element array layer 13. The microfocus element array layer 13 and the reflective layer 14 form a reflective microfocus layer. The micropattern layer 11 is arranged on the second surface. The micropattern layer 11 at least includes three micropattern units. The micropattern units are different from each other. The micropattern layer 11 is obtained through projection and imaging of a partial cut of a whole virtual three-dimensional image by the reflective microfocus layer. Because each micropattern unit is a partial cut of a whole virtual three-dimensional image, an observer cannot find out complete object and image information from a single micropattern unit. As a result, it is highly difficult to manufacture the imaging film, and counterfeiting becomes impossible.

A three-dimensional image with a continuous parallax and an occlusion relationship is observable through the transparent separation layer. In the present invention, through the joint action of a reflective microfocus layer and a micropattern layer 11, the reflective microfocus layer and the micropattern layer work together to provide a real three-dimensional image with a full field of view and dense points of view. The three-dimensional visual effect in the present invention is not susceptible to external ambient light, the effect is visible to naked eyes without wearing glasses, and the advantages such as a change along with an observation angle and a realistic three-dimensional effect are achieved.

In an embodiment, no optical interface is provided between any two of the micropattern layer, the transparent separation layer, and the reflective microfocus layer. That is, no reflection occurs when a light ray travels from one layer into another layer. Specifically, the micropattern layer 11, the transparent separation layer 12, and a reflective microfocus element are all made of materials with the same refractive index. Therefore, there is no interface reflection, and imaging resolution is high.

Each micropattern unit includes a plurality of lattices. Each microfocus unit at least covers one lattice or some microfocus units cover no lattice. Each micropattern unit includes a groove and a color nano ink filled in the groove. A width of the groove of the micropattern unit ranges from 0.5 micrometers to 15 micrometers, and an aspect ratio of the structure ranges from 0.5:1 to 3:1. Preferably, the groove has a width ranging from 1 micrometer to 5 micrometers and a depth ranging from 0.5 micrometers to 5 micrometers. An aperture of the micropattern unit in a microfocus unit layer ranges from 20 micrometers to 500 micrometers or from 500 micrometers to 1000 micrometers. The micropattern units are provided in a dense or sparse periodic regular arrangement manner such as a honeycomb arrangement or a square arrangement or an irregular aperiodic random arrangement manner.

The reflective layer 14 is formed by an optical film with a reflection effect, for example, is made of chromium, aluminum or silver or their alloys. A film thickness of the reflective layer 14 ranges from 20 nm to 100 nm. The reflective layer 14 may be formed by a multilayer film system made of a nonmetallic material, for example, zinc oxide, silicon dioxide, magnesium fluoride or titanium dioxide.

In this embodiment, the microfocus element array layer 13 and the reflective layer 14 are sampling compound layer and provide high optical efficiency, optical magnification, and a three-dimensional parallax effect. The micropattern layer 11 provides an image to be presented. To present a larger three-dimensional image and higher resolution, the image may be a partial cut of a whole image.

A thickness of the transparent separation layer 12 is less than 0.06 mm. The transparent separation layer 12 provides a distance between the reflective microfocus layer and the micropattern layer. The micropattern layer 11 is arranged within a range of +20% of an optimal imaging distance of the reflective microfocus layer. That is, an image distance of a main part of a virtual object at a reflective microfocus unit is L, and the thickness of the transparent separation layer is within L+20%*L.

In the present invention, to implement that an imaging film presents a three-dimensional image with a continuous parallax and an occlusion relationship, a method for preparing the micropattern layer is as follows:
step 1. obtaining a three-dimensional view of a target virtual image;
step 2. dividing, according to a visual occlusion status, a three-dimensional view of a virtual image observable at a viewing angle of human eyes, to obtain a discrete image point set;
step 3. making the discrete image point set sequentially pass through the transparent separation layer and the reflective microfocus layer in a viewing angle direction of the human eyes, reflecting the discrete image point set to the second surface of the transparent separation layer, and obtaining a corresponding discrete object point set at the second surface of the transparent separation layer, the discrete object point set forming a micropattern unit corresponding to the viewing angle of the human eyes;
wherein a distance between a preset point x_{L} in the discrete image point set and the imaging film is set to L, a refractive index of the imaging film is set to n, a thickness of the imaging film to 1, a radius of curvature of microfocus unit is set to R, a coordinate of an i^{th} microfocus element along an x axis is set to x_{i,MLA}, and an included angle between the preset point x_{L} and the microfocus element is set to a_{L},
the coordinate x and the angle a_{L} of the position of a light ray reflected to the micropattern layer satisfy:

$$( \begin{matrix}x \\ α\end{matrix} ) = ( \begin{matrix}1 & l \\ 0 & 1\end{matrix} ) ( \begin{matrix}1 & 0 \\ - \frac{2}{R} & 1\end{matrix} ) ( \begin{matrix}1 & - l \\ 0 & 1\end{matrix} ) ( \begin{matrix}1 & 0 \\ 0 & \frac{1}{n}\end{matrix} ) [ ( \begin{matrix}{x}_{i , MLA} \\ 0\end{matrix} ) + ( \begin{matrix}1 & - L \\ 0 & 1\end{matrix} ) ( \begin{matrix}{x}_{L} \\ {α}_{L}\end{matrix} ) ] ,$$

where the x axis is parallel to a surface of the imaging film;

step 4. traversing all viewing angles of the human eyes, and repeating step 2 and step 3 to obtain the micropattern array layer.

In the present invention, a period T of the reflective microfocus layer, a thickness D of the imaging film, and a refractive index n of the imaging film are designed by the following steps:

step 1. constructing a relational expression between a maximum viewing angle θ keeping hop crosstalk from occurring in the imaging film and the period T of the reflective microfocus layer, the thickness D of the imaging film, and the refractive index n of the imaging film:

$$θ = asin ( n \frac{T}{\sqrt{{T}^{2} + {D}^{2}}} ) ;$$

and

step 2. adjusting parameter values of T, D, and n, so that the maximum viewing angle θ keeping hop crosstalk from occurring in the imaging film is equal to 90 degrees.

The construction of a micropattern layer in the present invention is further described and explained below by using an example in which the three-dimensional view of the target virtual image is a dice.

FIG. 2 is a schematic diagram of a virtual three-dimensional object established according to the present invention.

A dice is selected as a virtual three-dimensional object. A three-dimensional diagonal of the device is along a z-axis direction. It is set that the dice is floating above an imaging plane. Each of the six faces corresponds to a number of dots. The virtual object is an entity and does not have a transparent property.

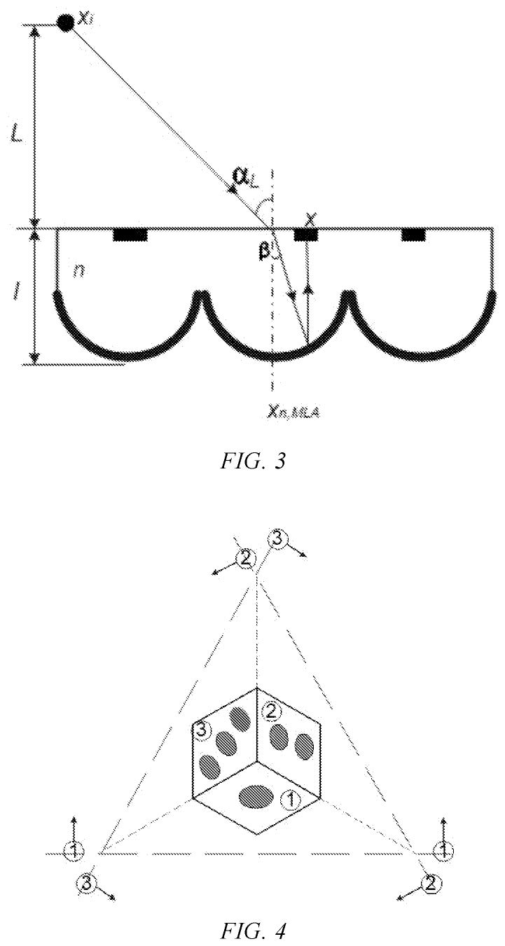

A distance between a point x_{L} on a virtual three-dimensional object dice and the imaging film is set to L, a refractive index of the imaging film is set to n, a thickness is set to 1, a radius of curvature of a microfocus element is set to R, a coordinate of an i^{th} microfocus element along an x axis is set to x_{i,MLA}, and an included angle between a point on the virtual object and the microfocus element is set to a_{L}. According to an optical transmission matrix, the coordinate x and the angle a_{L} of the position of a light ray reflected to the micropattern layer may be calculated according to the optical transmission matrix. For details, reference may be made to FIG. 3.

$$( \begin{matrix}x \\ α\end{matrix} ) = ( \begin{matrix}1 & l \\ 0 & 1\end{matrix} ) ( \begin{matrix}1 & 0 \\ - \frac{2}{R} & 1\end{matrix} ) ( \begin{matrix}1 & - l \\ 0 & 1\end{matrix} ) ( \begin{matrix}1 & 0 \\ 0 & \frac{1}{n}\end{matrix} ) [ ( \begin{matrix}{x}_{i , MLA} \\ 0\end{matrix} ) + ( \begin{matrix}1 & - L \\ 0 & 1\end{matrix} ) ( \begin{matrix}{x}_{L} \\ {α}_{L}\end{matrix} ) ] ,$$

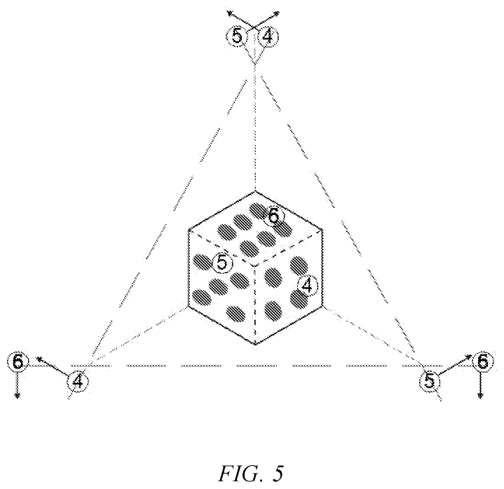

FIG. 4 and FIG. 5 are schematic structural diagrams of a micropattern unit structure in a micropattern layer calculated according to an occlusion relationship in the present invention. FIG. 4 represents a projection status of three surfaces with a surface normal direction facing upward of a dice. FIG. 5 represents a projection status of three surfaces with a surface normal direction facing upward of a dice.

In this embodiment, a dice is used as an example. A diagonal of the dice is along a vertical axis direction. FIG. 4 represents a projection status of three surfaces with a surface normal direction facing upward, that is, three surfaces with one dot, two dots, and three dots. A top view in a negative direction along the z axis is shown. According to an occlusion relationship, the surface with one dot is used as an example. Intersections between extension lines of edges and a surface of the imaging film are connected to form a line. An area above the line is used to calculate and reserve the image of one dot, and in addition an area below the line is discarded. Similarly, micropattern unit structures in projection areas of two dots and three dots may be calculated in different areas.

In this embodiment, a dice is used as an example. A diagonal of the dice is along a vertical axis direction. FIG. 5 represents a projection status of three surfaces with a surface normal direction facing downward, that is, three surfaces with four dots, two fives, and six dots. A top view in a negative direction along the z axis is shown. According to an occlusion relationship, the surface with six dots is used as an example. Intersections between extension lines of edges and a surface of the imaging film are connected to form a line. An area below the line is used to calculate and reserve the image of one dot, and in addition an area above the line is discarded. Similarly, micropattern unit structures in projection areas of four dots and five dots may be calculated in different areas.

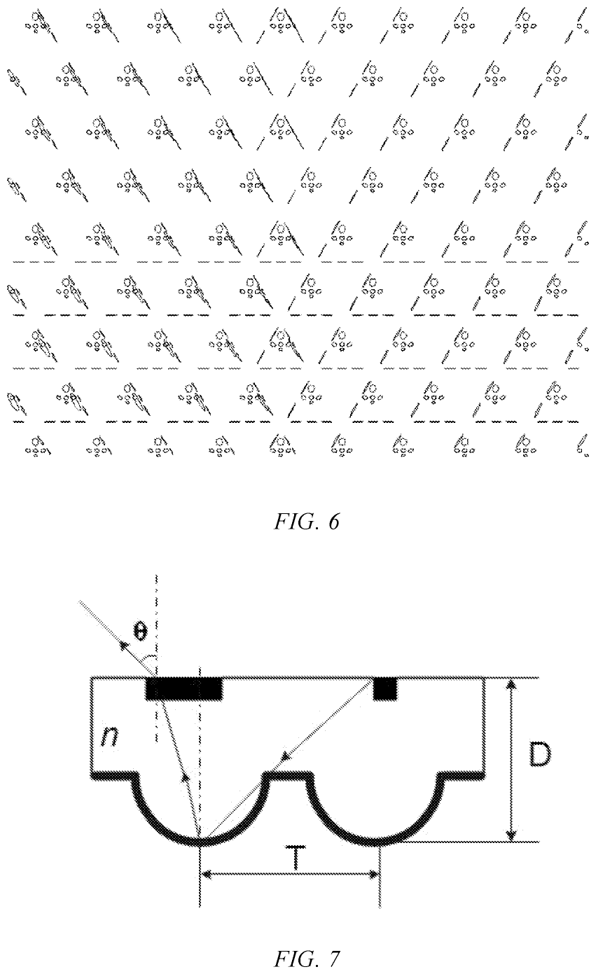

FIG. 6 is a schematic structural diagram of units in a partial area of a micropattern array according to the present invention. In this embodiment, according to the optical transmission matrix algorithm and the occlusion relationship algorithm described above, a schematic diagram of a plurality of micropattern units in a partial area of a micropattern layer is presented. As can be seen, due to the angles of light rays, each micropattern unit structure is unique.

FIG. 7 is a schematic structural diagram of calculating a viewing angle according to the present invention. It is set that the overall thickness of the film is D, a refractive index of the film is n, and an average period in the microfocus element array layer is T. As can be seen from the figure, the maximum viewing angle θ keeping hop crosstalk from occurring may be calculated according to the following formula

$$θ = asin ( n \frac{T}{\sqrt{{T}^{2} + {D}^{2}}} ) ;$$

When the average period T of the reflective microfocus element array is 130 micrometers, the thickness of the film is 70 micrometers, and the refractive index of the film is 1.5, the maximum viewing angle θ is 90 degrees. That is, a three-dimensional image can be observed in a full field of view range. The reason is that the reflective structure has a relatively short imaging distance, D is relatively small, and the obtained viewing angle is increased.

FIG. 8 shows a procedure of a manufacturing process of a reflective imaging film according to the present invention.

In this embodiment, a micropattern layer may support a groove-type structure and a conical nanostructure. First, a photoresist is applied on a base. An exposure technique is used to manufacture an island structure. A curved face structure is formed after hot melting. An ultraviolet imprint lithography technique is then used to manufacture a structure opposite to the photoresist structure to form a microfocus structure mold. Next, a similar process is used. A photoresist is applied on another base. An exposure technique is used to manufacture a micropattern array structure. An ultraviolet imprint lithography technique is then used to manufacture a micropattern array structure mold. Next, an aligned imprint technique and an ultraviolet micro-nano imprint technique are used to respectively imprint and manufacture a microfocus element array and a micropattern array on a first surface and a second surface of a layer of ultraviolet-sensitive material. Finally, a reflective layer is evaporated on a surface of the microfocus element array, to form a reflective microfocus element array. A material used as the reflective layer includes a metal material (for example, aluminum, chromium, silver or their alloys) material and a nonmetallic material (for example, silicon dioxide, titanium dioxide, silicon nitride, or silicon). An ink is filled on the surface of the micropattern array structure to form a micropattern array to complete the manufacturing of a reflective imaging film in the present invention. A three-dimensional image can be observed through the micropattern array structure.

Obviously, the foregoing embodiments are merely examples for clear description, rather than a limitation to implementations. For a person of ordinary skill in the art, other changes or variations in different forms may also be made based on the foregoing description. All implementations cannot and do not need to be exhaustively listed herein. Obvious changes or variations that are derived there from still fall within the protection scope of the invention of the present invention.

What is claimed is:

1. A reflective imaging film, comprising:
a transparent separation layer comprising a first surface and a second surface arranged opposite to each other;
a microfocus element array layer laminated on the first surface, the microfocus element array layer at least comprising three microfocus units;
a reflective layer covering an outer surface of the microfocus element array layer, the microfocus element array layer and the reflective layer forming a reflective microfocus layer; and
a micropattern layer arranged on the second surface, the micropattern layer at least comprising three micropattern units, the micropattern units being different from each other, the micropattern layer being obtained through projection and imaging of a partial cut of a whole virtual three-dimensional image by the reflective microfocus layer,
wherein a three-dimensional image with a continuous parallax and an occlusion relationship is observable through the transparent separation layer.

2. The reflective imaging film according to claim 1, wherein a method for preparing the micropattern layer comprises:
S1. obtaining a three-dimensional view of a target virtual image;
S2. dividing, according to a visual occlusion status, a three-dimensional view of a virtual image observable at a viewing angle of human eyes, to obtain a discrete image point set;
S3. making the discrete image point set sequentially pass through the transparent separation layer and the reflective microfocus layer in a viewing angle direction of the human eyes, reflecting the discrete image point set to the second surface of the transparent separation layer, and obtaining a corresponding discrete object point set at the second surface of the transparent separation layer, the discrete object point set forming a micropattern unit corresponding to the viewing angle of the human eyes; and
S4. traversing all viewing angles of the human eyes, and repeating S2 and S3 to obtain the micropattern layer.

3. The reflective imaging film according to claim 1, wherein S3 comprises:
setting a distance between a preset point x_{L} in the discrete image point set and the imaging film to L, a refractive index of the imaging film to n, a thickness of the imaging film to 1, a radius of curvature of microfocus unit to R, a coordinate of an i^{th} microfocus element along an x axis to x_{i,MLA}, and an included angle between the preset point x_{L} and the microfocus element to a_{L},
the coordinate x and the angle a_{L} of the position of a discrete object point of a light ray reflected to the micropattern layer satisfying:
$$( \begin{matrix}x \\ α\end{matrix} ) = ( \begin{matrix}1 & l \\ 0 & 1\end{matrix} ) ( \begin{matrix}1 & 0 \\ - \frac{2}{R} & 1\end{matrix} ) ( \begin{matrix}1 & - l \\ 0 & 1\end{matrix} ) ( \begin{matrix}1 & 0 \\ 0 & \frac{1}{n}\end{matrix} ) [ ( \begin{matrix}{x}_{i , MLA} \\ 0\end{matrix} ) + ( \begin{matrix}1 & - L \\ 0 & 1\end{matrix} ) ( \begin{matrix}{x}_{L} \\ {α}_{L}\end{matrix} ) ] ,$$
wherein the x axis is parallel to a surface of the imaging film.

4. The reflective imaging film according to claim 1, wherein a period T of the reflective microfocus layer, a thickness D of the imaging film, and a refractive index n of the imaging film are designed by steps of:
constructing a relational expression between a maximum viewing angle θ keeping hop crosstalk from occurring in the imaging film and the period T of the reflective microfocus layer, the thickness D of the imaging film, and the refractive index n of the imaging film:
$$θ = asin ( n \frac{T}{\sqrt{{T}^{2} + {D}^{2}}} ) ;$$
and
adjusting parameter values of T, D, and n, so that the maximum viewing angle θ keeping hop crosstalk from occurring in the imaging film is equal to 90 degrees.

5. The reflective imaging film according to claim 1, wherein no optical interface is provided between any two of the micropattern layer, the transparent separation layer, and the reflective microfocus layer.

6. The reflective imaging film according to claim 1, wherein a thickness of the transparent separation layer is less than 0.06 mm.

7. The reflective imaging film according to claim 1, wherein each micropattern unit comprises a plurality of lattices, and each microfocus unit at least covers one lattice, or some microfocus units cover no lattice.

8. The reflective imaging film according to claim 1, wherein the reflective layer is made from chromium, aluminum or silver, and a film thickness of the reflective layer ranges from 20 nm to 100 nm.

9. The reflective imaging film according to claim 1, wherein the micropattern unit comprises a groove and a color nano ink filled in the groove.

10. The reflective imaging film according to claim 1, wherein the micropattern layer is arranged within a range of +20% of an optimal imaging distance of the reflective microfocus layer.
